(19) United States
(12) Patent Application Publication
(10) Pub. No.: US 2004/0080931 A1
(43) Pub. Date: Apr. 29, 2004

(54) FLOOR STEREOSCOPIC MODEL DECORATION LAMP

(76) Inventor: Chih-Chen Chang, Hsinchu City (TW)

Correspondence Address: CHARLES E. BAXLEY, P.C., Hart, Baxley, Daniels & Holton, 90 John Street, Third Floor, New York, NY, 10038, US

(21) Appl. No.: 10/280,808

(22) Filed: Oct. 28, 2002

(51) Int. Cl. F21S 6/00

(52) U.S. Cl. 362/124; 362/249

(57) ABSTRACT

The present invention provides a floor stereoscopic model decoration lamp, which is comprised of an inflatable transparent inner bladder working as a frame, and a colored figured decoration coast cover the outside of the inner bladder, the light source is hidden into the inside of the inner bladder giving out light via the transparent inner bladder and the decoration coast to appear to colored brighten stereoscopic model. In transportation, firstly draining away the inside air, then fold up the inner bladder and the decoration coast to reduce the volume to minimal.

### BACKGROUND OF THE INVENTION

1. Field of the Invention

The present invention relates to a lamp, and more particularly to a floor stereoscopic model decoration lamp with an inflated internal frame and colored cloth.

2. Description of Prior Art

For setting off the festival atmosphere by contrast, the floor stereoscopic decoration lamps are used more often in recent years. In accordance with the conventional floor stereoscopic model decoration lamps, they are divided into three styles, as shown in FIG. 3 to FIG. 5.

A conventional floor stereoscopic decoration lamp 1 is shown in FIG. 3, structured by a tied metal frame 11, in which the bulbs 12 are tied on the metal frame 11 separately. When the bulb 12 is lightening, the stereoscopic model drew out by the bulbs 12 can be seen. But in this decoration lamp 1, just only the outline of the frame is drew out, so that the outward appearance seem to lack physical impression; and tying the crossover points 13 of the metal frame 11 is to take much time; and due to the stereoscopic model of the lamp, package occupies much volume and the transportation cost is higher.

A conventional floor stereoscopic decoration lamp 2, shown in FIG. 4, is an inflating molded plastic shell with a hollow vanity 21 with an illuminator 22 fastened at the inside. When lighting the illuminator 22, via the vanity 21 the inflated shell appears to lighting stereoscopic model. This product seems to solve the stereoscopic model problem, but the package and transportation problems are still remained.

A conventional floor stereoscopic decoration lamp 3, shown in FIG. 5, is consisted of several inflating molded plastic shells with hollow vanity 31 in each; the illuminator 32 is built upon inside of the hollow vanity 31. In this way, a whole body is divided into several smaller pieces for facilitating transporting, but the sum volume and packaging material used will not be reduced, but the mold die set cost is great increased.

### OBJECTS AND SUMMARY OF THE INVENTION

It is therefore a main object of the present invention to provide a floor stereoscopic model decoration lamp that can not only reduce the package and the transportation costs, but also keep the whole stereoscopic model in physical impression.

For achieving said object, the present invention to provide a floor stereoscopic model decoration lamp comprised of an inflatable transparent inner bladder working as a frame, and a colored figured coast putting over said frame, and the light source hidden into the hollow inside of the inner bladder giving out the light via the transparent inner bladder and the coast to appear to brighten stereoscopic colored model; when packaging and transportation, just need to drain away the air inflated at inside, then fold up the bladder and the coast so as to reduce the package to minimal.

### BRIEF DESCRIPTION OF THE DRAWINGS

FIG. 1 is an exploded solid view of the present invention.

FIG. 2 is a diagram showing the draining off state of the present invention.

FIG. 3 is a solid view of the prior art (A).

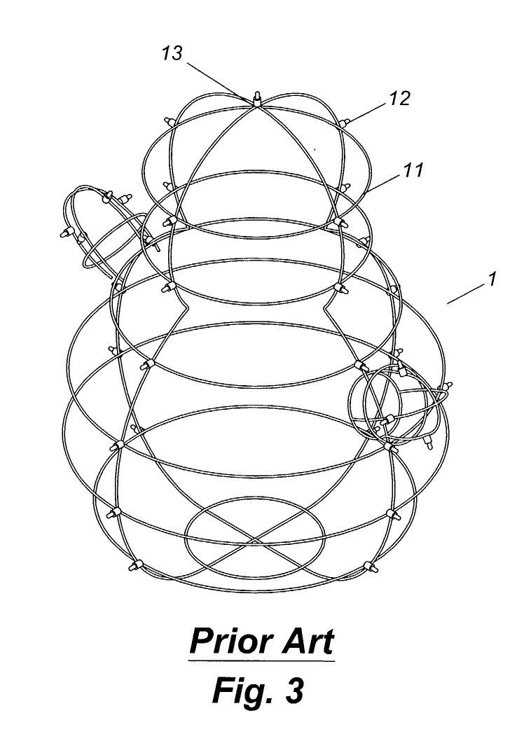

FIG. 4 is a solid view of the prior art (B).

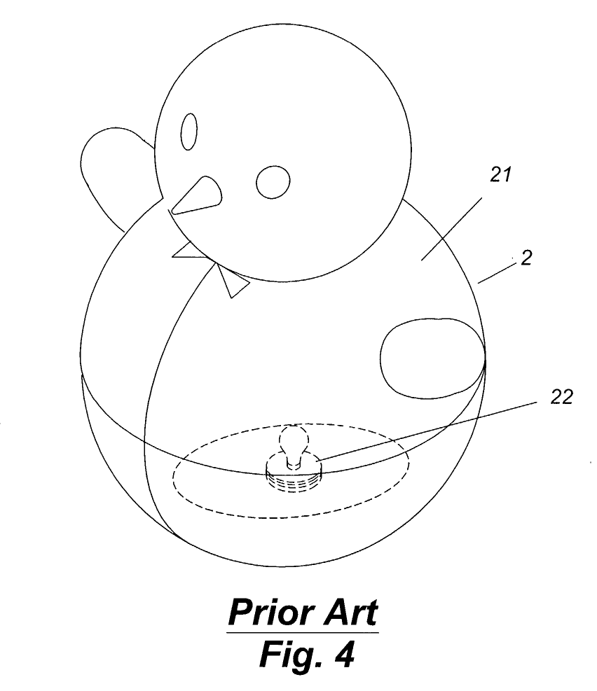

FIG. 5 is an exploded solid view of the prior art (C).

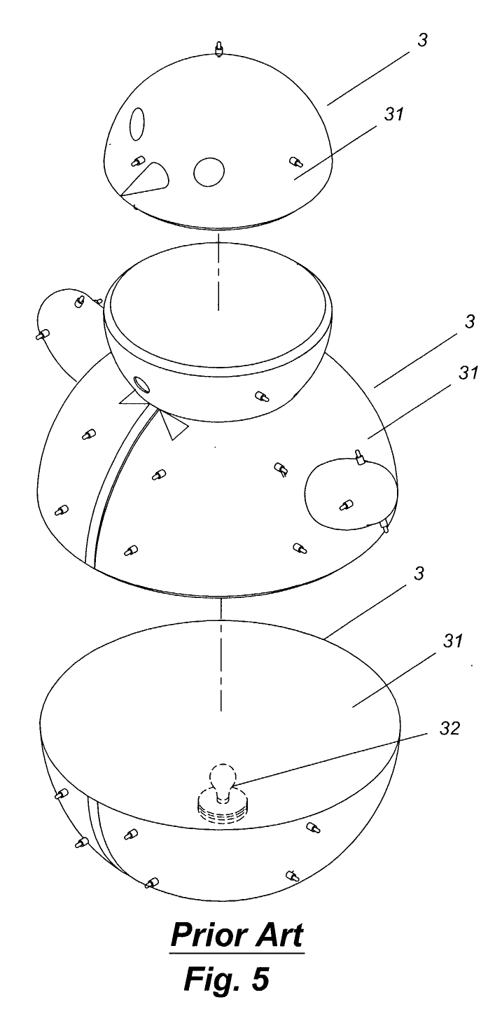

### DETAILED DESCRIPTION OF PREFERRED EMBODIMENTS

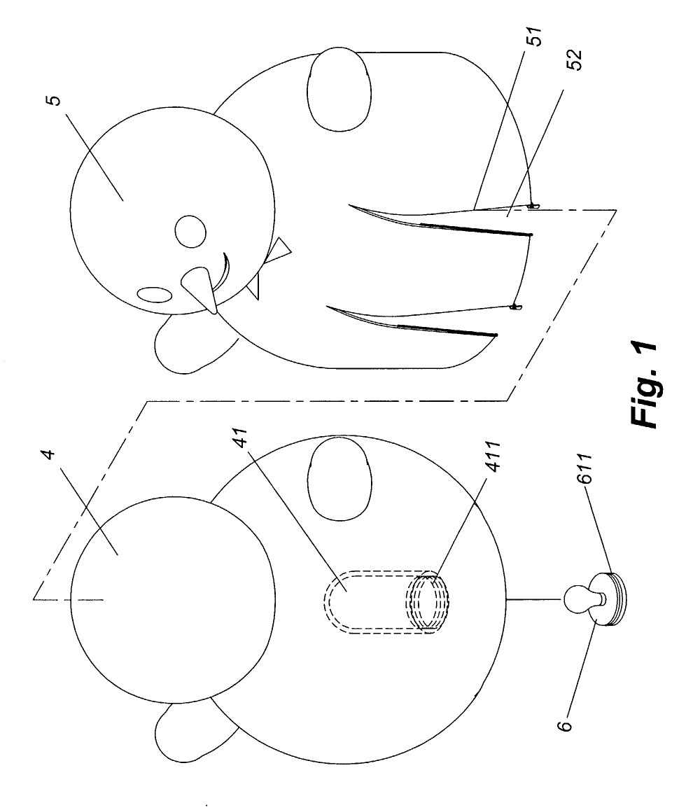

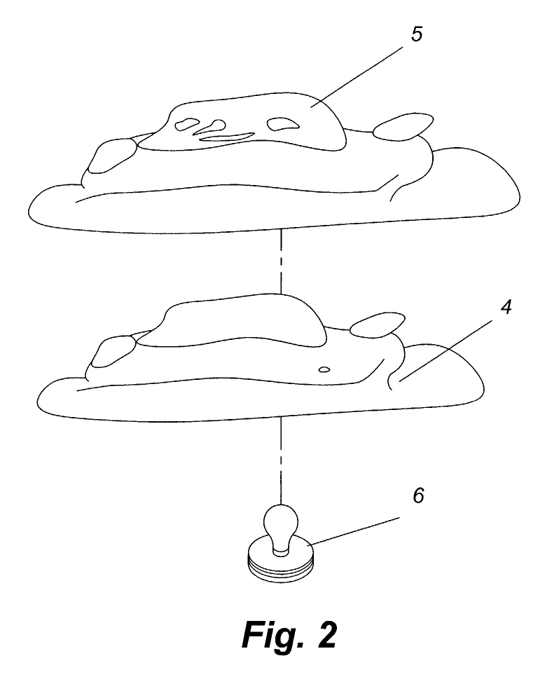

Referring to FIG. 1, a floor stereoscopic model decoration lamp provided by the present invention including an inflatable transparent inner bladder 4 working as a frame with a pre-molded light housing 41 curved inward for securing an illuminator 6 at the inside on a source nipple 411 of the light housing 41 with the thread 611, and a decoration coast 5 made of stretch cloth, common cloth, plastic cloth or paper painting with figures and colors, and is tailored following the outside shape of the inner bladder 4. In assembling, firstly inflate the transparent inner bladder 4 with air, and secure on the illuminator 6, finally put on the decoration coast 5 over the inner bladder 4. In packaging, firstly drain away air of the inner bladder 4, as shown in FIG. 2, then fold up the inner bladder 4 and the decoration coast 5 to form a small package.

If the stereoscopic model of the decoration lamp is more complicate, for facilitating disassembly, the decoration coast 5 can be tailored into several pieces along the proper cutting lines 52, and join them together with some sewing components like zip fastener 51 or some knots (not shown in drawing).

Since concerning on the balance, referring to some conventional inflatable toys set upon a sand room or water chamber (not indicated in drawing), so that the stereoscopic model decoration lamp can stand more stably.

I claim:

1. A floor stereoscopic model decoration lamp holding in an illuminator at inside, wherein the decoration lamp is comprised of an inflatable transparent inner bladder as a frame, and a colored figured decoration coast cover the outside of the inner bladder.

2. A floor stereoscopic model decoration lamp as claimed in claim 1, wherein said decoration coast can have cutting lines with sewing components for fastening attachments.
